(19) United States
(12) Patent Application Publication
(10) Pub. No.: US 2007/0151988 A1
(43) Pub. Date: Jul. 5, 2007

(54) CONSTANT PRESSURE DELIVERY VESSEL AND SYSTEM

(76) Inventors: Victor M. Saucedo, Willowbrook, IL (US); M. Usman Ghani, Bolingbrook, IL (US)

Correspondence Address: AIR LIQUIDE INTELLECTUAL PROPERTY DEPT., 2700 POST OAK BLVD., SUITE 1800, HOUSTON, TX, 77056, US

(21) Appl. No.: 11/566,641

(22) Filed: Dec. 4, 2006

Related U.S. Application Data
(60) Provisional application No. 60/750,169, filed on Dec. 14, 2005.

(51) Int. Cl. G01F 11/00; B65D 83/00

(52) U.S. Cl. 222/389; 222/399

(57) ABSTRACT

System and method for providing a constant pressure of a gas or a fluid. The method includes measuring one or more output flows from a supply tank and determining whether one or more input flows to the supply tank balance the one or more output flows. The method also includes modifying at least one of the one or more input flows to balance the one or more output flows when the one or more input flows to the supply tank do not balance the one or more output flows, thereby maintaining the pressure within the supply tank.

### CROSS-REFERENCE TO RELATED APPLICATIONS

This application claims the benefit under 35 U.S.C. § 119(e) to provisional application No. 60/750,169, filed Dec. 14, 2005, the entire contents of which are incorporated herein by reference.

### BACKGROUND

In some cases, a furnace may be used to provide heat for an industrial process. To provide the necessary heat, the furnace may burn a mixture of fuel and air (e.g., natural gas and air). Depending on process requirements, the mixture of fuel and air may be closely regulated to ensure that combustion in the furnace occurs under desired conditions. For example, at a given ratio of air to fuel, referred to as the stoichiometric ratio, all of the fuel and oxygen in the furnace will be consumed during combustion. Also, in some cases, the furnace may be operated with an excess amount of fuel (e.g., with an air-fuel ratio less than the stoichiometric ratio), referred as a fuel-rich operation. Similarly, in some cases, the furnace may be operated with an excess amount of air, (e.g., with an air-fuel ratio greater than the stoichiometric ratio), referred as a fuel-lean operation.

In some cases, the furnace may also use a mixture of fuel and air which varies over time. Where the mixture of fuel and air used by the furnace varies over time, maintaining a desired pressure of air and/or fuel sources while changing air-fuel flow rates may be difficult. For example, if the amount of air supplied to the furnace is varied, pressure provided by the air source (e.g., a compressor) may also vary. The air pressure may vary inversely with the amount used, e.g., as more air is used, pressure from the air source may decrease, and as less air is used, pressure from the air source may increase. Where the pressure from one or more air or fuel sources used by the furnace varies, the difficulty of controlling the supply of air and fuel to the furnace may be increased.

Accordingly, what is needed is a method and system for providing a constant pressure of gas which is supplied at a changing flow rate.

### SUMMARY

Embodiments of the invention generally provide a system and method of maintaining a pressure within a supply tank. In one embodiment, the method includes measuring one or more output flows from the supply tank and determining whether one or more input flows to the supply tank balance the one or more output flows. The method also includes modifying at least one of the one or more input flows to balance the one or more output flows, thereby maintaining the pressure within the supply tank when the one or more input flows to the supply tank do not balance the one or more output flows.

One embodiment of the invention also provides a system including a supply tank and a controller configured. The controller is configured to measure one or more output flows from the supply tank and determine if one or more input flows to the supply tank balance the one or more output flows. If the one or more input flows to the supply tank do not balance the one or more output flows, the controller is configured to modify at least one of the one or more input flows to balance the one or more output flows, thereby maintaining a pressure within the supply tank.

Another embodiment provides a method of maintaining a constant pressure in a supply vessel. The method includes providing one or more input flows to the supply vessel and providing one or more output flows from the supply vessel. If the one or more output flows from the supply vessel are greater than the one or more input flows to the supply vessel, at least a first portion of at least one of the one or more input flows is diverted from the supply vessel to a buffer tank.

One embodiment also provides a system including a supply tank with one or more output flows and one or more input flows, a buffer tank, and a valve positioned between the supply tank and the buffer tank. The valve is configured to divert at least a first portion of at least one of the one or more input flows from the supply vessel to a buffer tank if the one or more output flows from the supply vessel are greater than the one or more input flows to the supply vessel.

Another embodiment provides a method of maintaining a constant pressure in a supply vessel. The method includes providing one or more input flows to the supply vessel and providing one or more output flows from the supply vessel. The method further includes actuating a piston to decrease the volume of the supply vessel if the one or more output flows from the supply vessel are greater than the one or more input flows to the supply vessel, thereby maintaining the constant pressure in the supply vessel.

One embodiment provides a system including a supply tank with one or more output flows and one or more input flows and a piston. The system also includes a control mechanism for the piston configured to actuate the piston to decrease the volume of the supply vessel if the one or more output flows from the supply vessel are greater than the one or more input flows to the supply vessel, thereby maintaining the constant pressure in the supply vessel.

A further embodiment of the invention provides a method of providing an input flow. The method includes flowing a first stream of a gas from a first source at a first fixed flow rate and flowing a second stream of the gas from the first source to a buffer tank at a second fixed flow rate. The method also includes flowing an output stream of the gas from the buffer tank to an oscillating valve and combining the first stream of the gas with a third stream of the gas to form the input flow. The method further includes actuating the oscillating valve during an oscillation cycle to change a flow rate of the third stream of the gas to maintain a desired flow rate of the input flow.

Another embodiment of the invention provides a system including a buffer tank and a first stream of a gas flowing from a first source at a first fixed flow rate. The system also includes a second stream of the gas flowing from the first source to the buffer tank at a second fixed flow rate. The system further includes an output stream of the gas flowing from the buffer tank to an oscillating valve and a connection combining the first stream of the gas with a third stream of the gas to form the input flow. The system also provides a control mechanism configured to actuate the oscillating valve during an oscillation cycle to change a flow rate of the third stream of the gas to maintain a desired flow rate of the input flow.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 illustrates a system for maintaining a constant pressure in a supply vessel according to one embodiment of the invention;

FIG. 2 illustrates a process for maintaining a constant pressure in a supply vessel according to one embodiment of the invention;

FIG. 3 illustrates a system including a buffer tank for maintaining a constant pressure in a supply vessel according to one embodiment of the invention;

FIG. 4 illustrates a process for maintaining a constant pressure in a supply vessel using a buffer tank according to one embodiment of the invention;

FIG. 5 illustrates a system including a piston for maintaining a constant pressure in a supply vessel according to one embodiment of the invention;

FIG. 6 illustrates a process for maintaining a constant pressure in a supply vessel using a piston according to one embodiment of the invention;

FIG. 7 illustrates a system for providing an input flow to a process according to one embodiment of the invention; and

FIG. 8 illustrates a process for providing an input flow to a process according to one embodiment of the invention.

### DESCRIPTION OF PREFERRED EMBODIMENTS

Embodiments of the invention generally provide a system and method of maintaining a pressure within a supply tank. In one embodiment, the method includes measuring one or more output flows from the supply tank and determining whether one or more input flows to the supply tank balance the one or more output flows. The method also includes modifying at least one of the one or more input flows to balance the one or more output flows, thereby maintaining the pressure within the supply tank when the one or more input flows to the supply tank do not balance the one or more output flows.

While described below with respect to providing air to a combustion process such as an oscillating combustion process, embodiments of the invention may be used to provide any type of gas or fluid to any type of process known to those skilled in the art.

### EXAMPLES

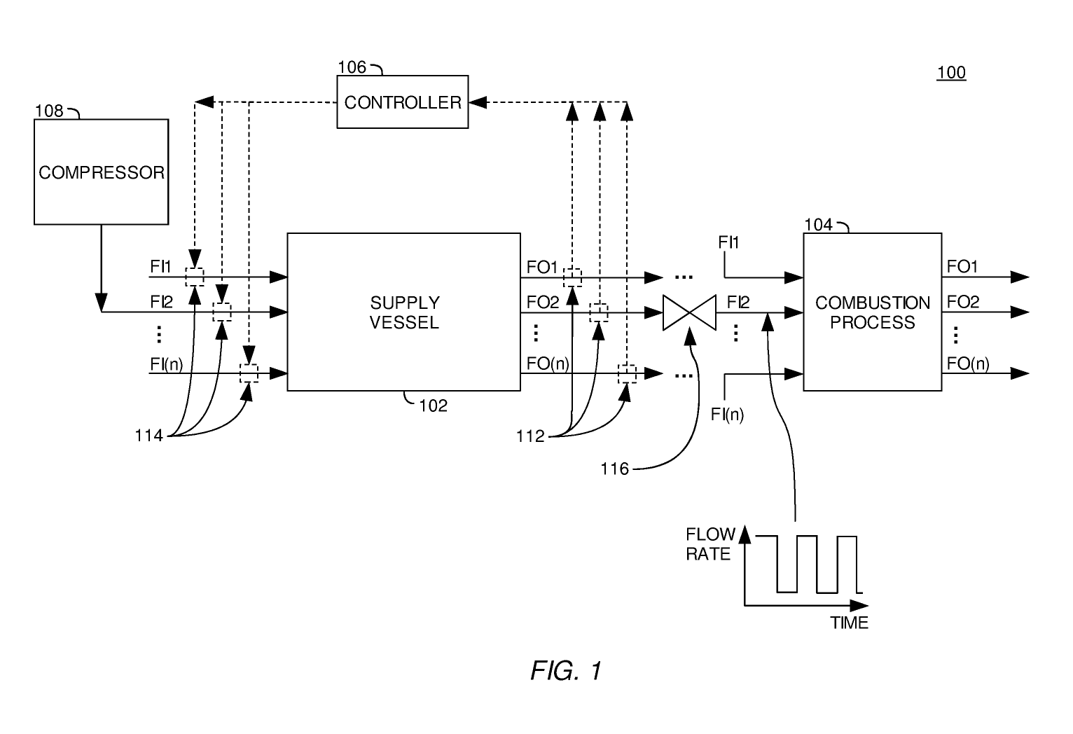

FIG. 1 illustrates a system 100 for maintaining a constant pressure in a supply vessel 102 according to one embodiment of the invention. As depicted, the supply vessel 102 may have one or more input flows (FI1, FI2 . . . FI(n)) as well as one or more output flows (FO1, F02 . . . FO(n)). In some cases, input flows may be provided from the output of other processes performed in the system 100 or from an apparatus designed for the purpose, such as a compressor 108 or a larger, higher pressure storage tank. The one or more output flows may also be provided to other processes performed in the system, including a combustion process 104. In some cases, the combustion process 104 may have one or more input flows as well as one or more output flows. For example, the compressor 108 and supply vessel 102 may provide air to the combustion process 104 while one or more other inputs may provide fuel to the combustion process 104. While described herein with respect to a supply vessel 102 that provides air to a combustion process 104, fuel may also be supplied to the combustion process 104 in a similar manner (e.g., using a corresponding supply vessel to regulate the fuel input to the combustion process 104).

In one embodiment of the invention, the combustion process 104 may be an oscillating combustion process. In an oscillating combustion process, combustion may be performed in a multi-part, repeating cycle. In a particular embodiment, the cycle includes a first (and typically longer) part in which combustion may be performed with excess fuel (e.g., with a fuel rich air-fuel ratio). In a second (and typically shorter) part of the cycle, combustion may be performed with excess air (e.g., with a fuel lean air-fuel ratio). The first part and second part of the cycle may be repeated continuously during the combustion process. By operating the combustion process 104 in a fuel lean mode for the first part of the cycle, the fuel used during the first part may not be totally consumed. By operating the combustion process 104 in a fuel rich mode for the second part of the cycle, the unused fuel from the first part may be consumed. Furthermore, by operating the combustion process 104 in a fuel lean manner for the majority of the cycle, the temperature of the combustion process 104 may be reduced, thereby reducing nitrous-oxide pollutants (NOX) produced by the combustion process 104.

In one embodiment of the invention, an oscillating valve 116 may be used to vary the flow rate of air between the supply vessel 102 and combustion process 104, thereby providing the fuel rich and fuel lean portions of the combustion cycle as described above. As mentioned above, where the amount of air being used by the combustion process 104 varies over time, the pressure of the air in the supply vessel 102 may vary according to the amount of air being used.

In one embodiment of the invention, a controller 106 may be used to maintain a constant pressure (e.g., for a given volume and temperature) of gas within the supply vessel 102. For example, the controller 106 may maintain a mass-balance of flows into the supply vessel 102 and flows out of the supply vessel 102, thereby maintaining a constant quantity of gas within the supply vessel 102 and providing a constant pressure at the output flows for a given volume and temperature of the vessel 102.

In order to perform the mass-balance, the controller 106 may be configured to perform flow measurements at both the inputs to and outputs from the supply vessel 102. The flow measurements at the outputs of the supply vessel may be performed with sensors 112 for each output flow being measured. Similarly, control and measurement of the flows at the inputs of the supply vessel 102 may be performed using flow regulators 114 (e.g., valves) for each input flow being measured. The measurements performed using the sensors 112 and regulators 114 may be performed in any manner, for example, by using a flow transmitter, mass flow meter, pressure meter, and/or rotor meter. Also, because the mass-balance may be performed with flow meters, in some cases maintaining the pressure within the supply vessel 102 may be performed without a pressure sensor which measures the pressure of the gas within the supply vessel 102.

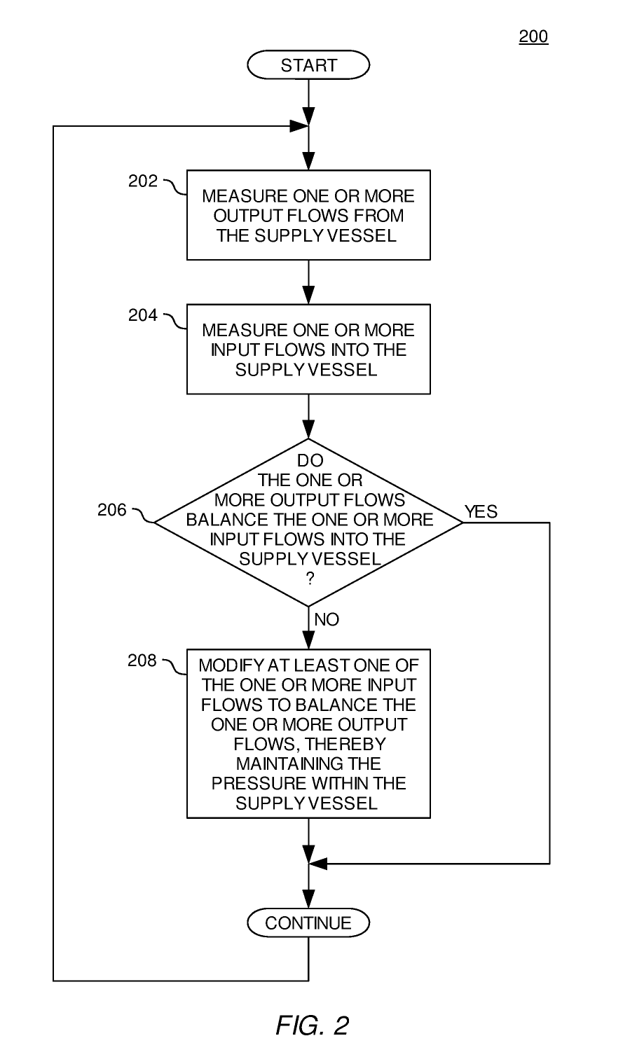

FIG. 2 illustrates a process 200 for maintaining a constant pressure in a supply vessel 102 according to one embodiment of the invention. In one embodiment of the invention, the process 200 may be performed by the controller 106. The process 200 may begin at step 202 where one or more output flows from the supply vessel 102 may be measured, for example, using the output flow sensors 112. Then, at step 204, one or more input flows into the supply vessel may be measured, for example, using the input flow regulators 114. At step 206, a determination may be made of whether the one or more output flows balance the one or more input flows into the supply vessel 102.

If the one or more output flows do not balance the one or more input flows, then at step 208 at least one of the one or more input flows may be modified (e.g., using a corresponding input flow regulator 114) to balance the one or more output flows, thereby maintaining the pressure within the supply vessel 102. For example, if the sum of the one or more output flows is greater than the sum of the one or more input flows, the amount of flow from an input flow may be increased so that the total outflow matches the total inflow. Similarly, if the total outflow is less than the total inflow, then the total inflow may be decreased via at least on of the one or more input flows so that the total outflow again matches the total inflow. In some cases, a single input flow may be modified to maintain the balance. Optionally, in one embodiment, each of the inflows may be given a preference in determining which inflow should be modified. For example, if one inflow comes from a separate supply tank and another inflow comes from a compressor 108, the inflow from the supply tank may be modified first to maintain the balance between inflows and outflows, with the inflow from the compressor only being modified if modifying the first inflow alone is insufficient to balance the sum of the outflows.

### Using a Buffer Tank to Maintain a Constant Pressure

In one embodiment of the invention, a buffer tank may be used to maintain a constant pressure in a supply vessel 102. For example, where the one or more input flows into the supply vessel 102 are greater than the one or more output flows from the supply vessel 102, the pressure in the supply vessel 102 may begin to rise. In order to offset the rise in pressure in the supply vessel 102, a portion of one or more the input flows may be diverted from the supply vessel 102 to a buffer vessel, thereby offsetting the increase in pressure in the supply vessel 102. Also, where the one or more input flows into the supply vessel 102 are less than the one or more output flows from the supply vessel 102, the pressure in the supply vessel 102 may begin to fall. In order to offset the fall in pressure in the supply vessel 102, a portion of one or more the input flows may be provided from the buffer vessel to the supply vessel 102, thereby offsetting the fall in pressure.

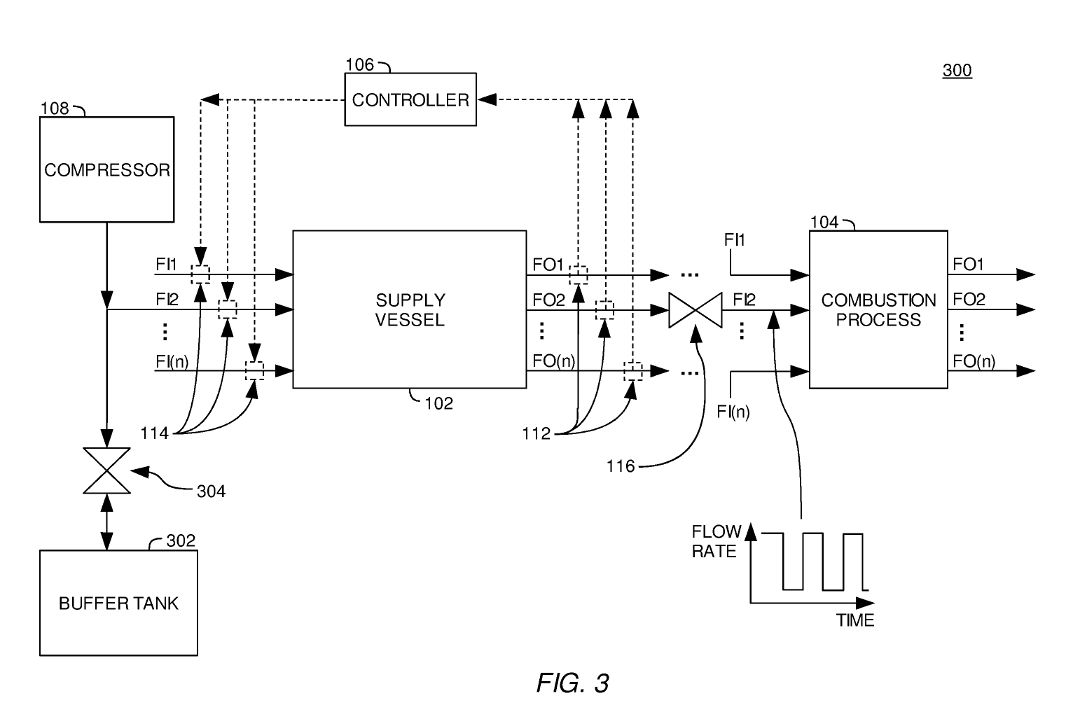

FIG. 3 illustrates a system 300 including a buffer tank 302 for maintaining a constant pressure in a supply vessel 102 according to one embodiment of the invention. As depicted, the system 300 may include a compressor 108 which provides a constant flow of gas as an input to the supply vessel 102. The system 300 may also include a valve 304 between the buffer tank 302 and one of the input flows (FI2) into the supply vessel 102. The valve 304 may, for example, be a pressure sensitive valve which is configured to divert a portion of the inflow (e.g., from compressor 108 or another source) to the buffer tank 302 when the pressure in the supply vessel 102 rises above a desired pressure, thereby maintaining the desired pressure in the supply vessel 102.

In one embodiment, the valve 304 may also be configured to provide a portion of the inflow from the buffer tank 302 when the pressure in the supply vessel 102 falls below the desired pressure. In one embodiment of the invention, the buffer tank 302 and valve 304 may also be used in conjunction with the controller 106, sensors 112, and flow regulators 114 described above with respect to FIGS. 1-2. Optionally, the buffer tank 302 and valve 304 may be used without the regulation system provided by the controller 106, sensors 112, and flow regulators 114. Also, in one embodiment of the invention, the pressure regulation provided by the buffer tank 302 may be provided without a pressure sensor in the supply vessel 102.

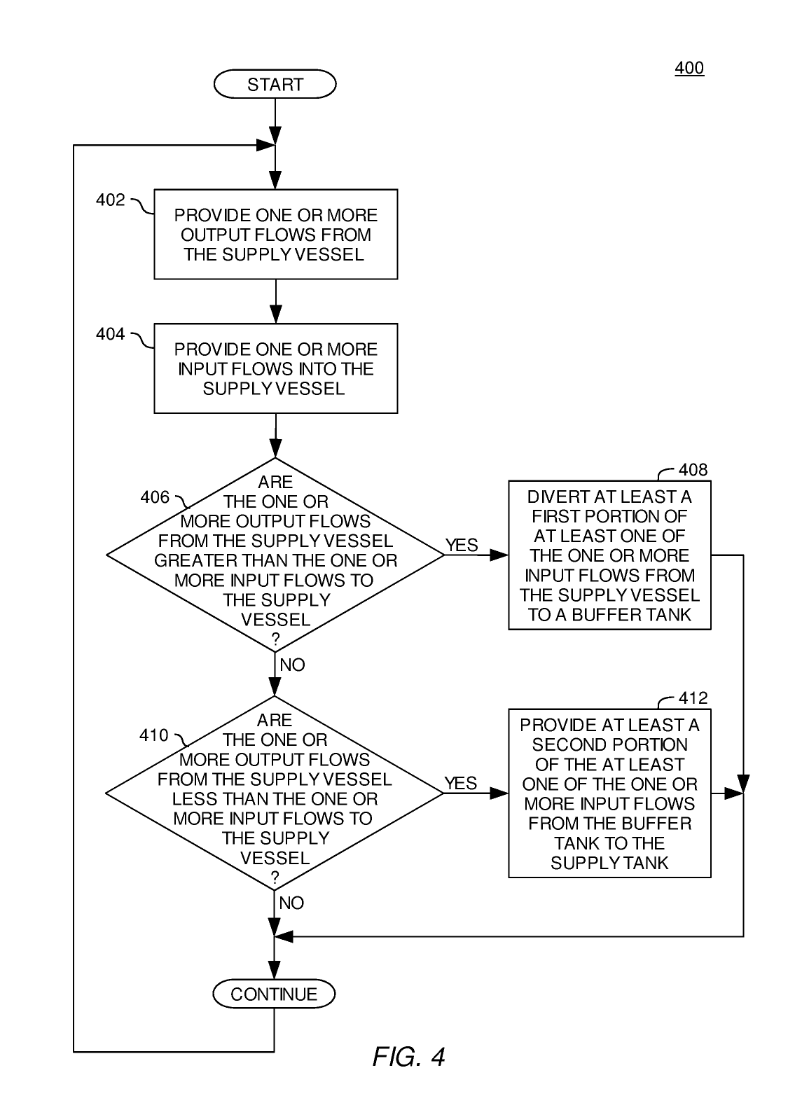

FIG. 4 illustrates a process 400 for maintaining a constant pressure in a supply vessel using a buffer tank 302 according to one embodiment of the invention. The process 400 may begin at step 402 where one or more output flows are provided from the supply vessel 102. At step 404, one or more input flows input the supply vessel 102 may be provided. At step 406, a determination may be made of whether the one or more output flows from the supply vessel 102 are greater than the one or more input flows to the supply vessel 102. If a determination is made that the one or more input flows are greater than the one or more output flows, then at least a first portion of at least one of the one or more input flows from the supply vessel 102 may be diverted from the supply vessel 102 to the buffer tank 302 at step 408. As described above, by diverting the input flow to the buffer tank 302, a rise in pressure in the supply vessel 102 may be prevented, thereby maintaining a constant pressure in the supply vessel 102.

If a determination is made that the one or more input flows are not greater than the one or more output flows, then at step 410 a determination may be made of whether the one or more output flows from the supply vessel 102 are less than the one or more input flows to the supply vessel 102. If a determination is made that the one or more output flows from the supply vessel 102 are less than the one or more input flows to the supply vessel 102, then at step 412 at least a second portion of the at least one of the one or more input flows may be diverted from the buffer tank 302 to the supply tank 102, thereby maintaining a constant pressure in the supply vessel 102. Also, in one embodiment of the invention, where the one or more output flows from the supply vessel 102 are the same as the one or more input flows to the supply vessel 102, the diversion of the input flows to or from the buffer vessel 304 may be unnecessary.

### Using a Piston to Maintain a Constant Pressure

In one embodiment of the invention, a piston may be used to modify the volume of a supply vessel 102 to provide a constant pressure within the supply vessel 102. For example, where the one or more input flows into the supply vessel 102 are greater than the one or more output flows from the supply vessel 102, the pressure in the supply vessel 102 may begin to rise. In order to offset the rise in pressure in the supply vessel 102, the piston may be actuated in a first direction to increase the volume of the supply vessel 102, thereby offsetting the increase in pressure in the supply vessel 102. Also, where the one or more input flows into the supply vessel 102 are less than the one or more output flows from the supply vessel 102, the pressure in the supply vessel 102 may begin to fall. In order to offset the fall in pressure in the supply vessel 102, the piston may be actuated in a second direction to decrease the volume of the supply vessel 102, thereby offsetting the fall in pressure and maintaining a constant pressure in the supply vessel 102.

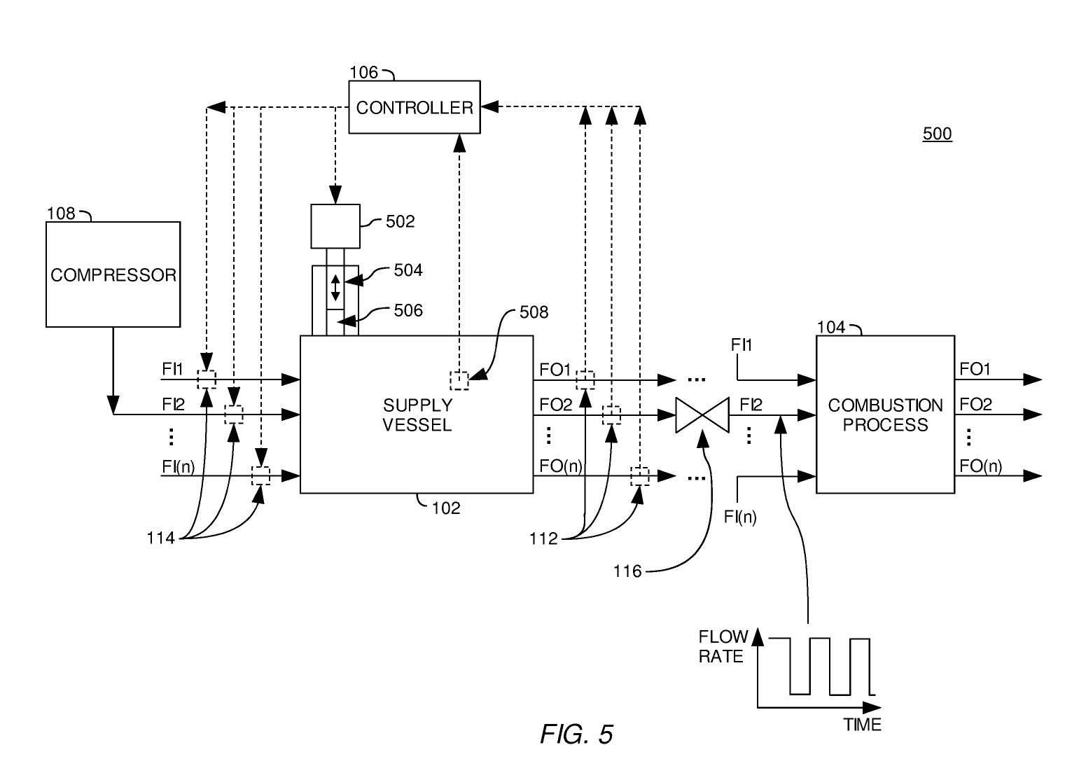

FIG. 5 illustrates a system 500 including a piston 504 for maintaining a constant pressure in a supply vessel 102 according to one embodiment of the invention. As depicted, the piston 504 may be attached to the supply vessel 102 such that when the piston 504 is actuated, the internal volume 506 of the supply vessel 102 is changed. As described above, the piston 504 may be used to modify the volume 506 of the supply vessel 102 in such a manner that a constant pressure within the supply vessel 102 is maintained.

For example, in one embodiment of the invention, the controller 106 may be used to measure the pressure of the supply vessel 102, for example, using a pressure sensor 508. If the controller 106 detects that the pressure within the supply vessel 102 is rising above the desired pressure, then the controller 106 may actuate the piston 504 in a first direction (e.g., out of the supply vessel 102) to increase the volume 506 of the supply vessel 102 and maintain a constant pressure in the supply vessel 102. The controller 106 may actuate the piston 504 using an actuation mechanism 502 (e.g., a hydraulic system or a solenoid). Also, if the controller 106 detects that the pressure within the supply vessel 102 is falling below the desired pressure, then the controller 106 may actuate the piston 504 in a second direction (e.g., into the supply vessel 102) to decrease the volume 506 of the supply vessel 102 and maintain a constant pressure in the supply vessel 102. In one embodiment, the movement of the piston 504 may also be controlled by a pressure control valve which may be used to determine whether the pressure in the supply vessel 102 is increasing or decreasing with respect to a desired pressure level.

In one embodiment of the invention, instead of controlling the piston 504 with the controller 106, the piston 504 may be a friction free piston. If the pressure inside the supply vessel 102 increases, the friction free piston may actuate in a first direction to increase the volume 506 of the supply vessel 102 and maintain a constant pressure within the supply vessel 102. Similarly, if the pressure inside the supply vessel 102 decreases, the friction free piston may actuate in a second direction to decrease the volume 506 of the supply vessel 102 and maintain a constant pressure within the supply vessel 102. Optionally, instead of a piston 504, a flexible membrane could also be used to change the volume 506 of the supply vessel 102 as described above.

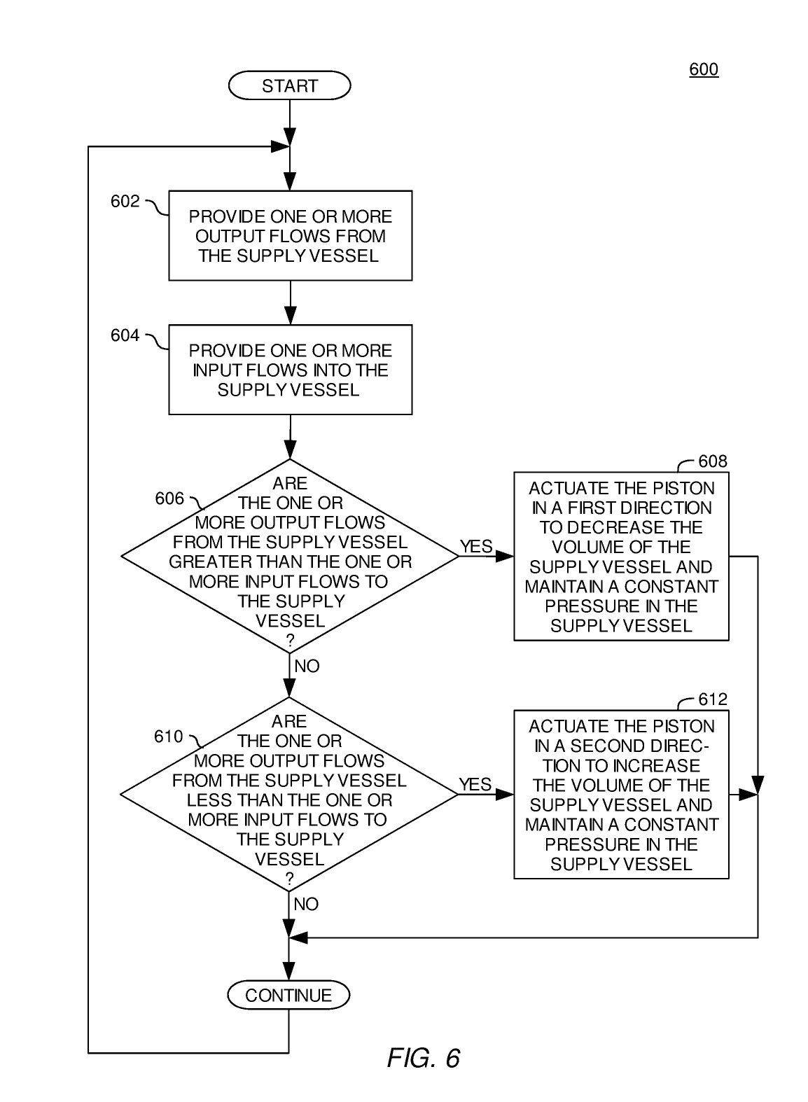

FIG. 6 illustrates a process 600 for maintaining a constant pressure in a supply vessel using a piston 504 according to one embodiment of the invention. As depicted, the process 600 may begin at step 602 where one or more output flows from the supply vessel 102 are provided. At step 604, one or more input flows into the supply vessel 102 may also be provided. At step 606, a determination may be made of whether the one or more output flows are greater than the one or more input flows. If the one or more output flows are greater than the one or more input flows, then at step 608 the piston 504 may be actuated in a first direction to decrease the volume 506 of the supply vessel 102 and maintain a constant pressure in the supply vessel 102.

If the one or more output flows are not greater than the one or more input flows, then at step 610 a determination may be made of whether the one or more output flows are less than the one or more input flows. If the one or more output flows are less than the one or more input flows, then at step 612 the piston may be actuated in a second direction to increase the volume 506 of the supply vessel 102 and thereby maintain a constant pressure in the supply vessel 102. Also, where the input flows into the supply vessel 102 balance the output flows from the supply vessel 102, the piston 504 may remain at a given point to maintain the desired pressure in the supply vessel 102.

### Using a Constant Flow of Gas to Maintain a Constant Pressure

In one embodiment of the invention, an input flow to an oscillating combustion process 104 may be provided via multiple streams of gas. For example, a first stream of gas provided at a fixed flow rate may be combined with a second stream of gas which is provided at an oscillating flow rate to provide an accurate input flow to a process such as an oscillating combustion process which uses the input flow.

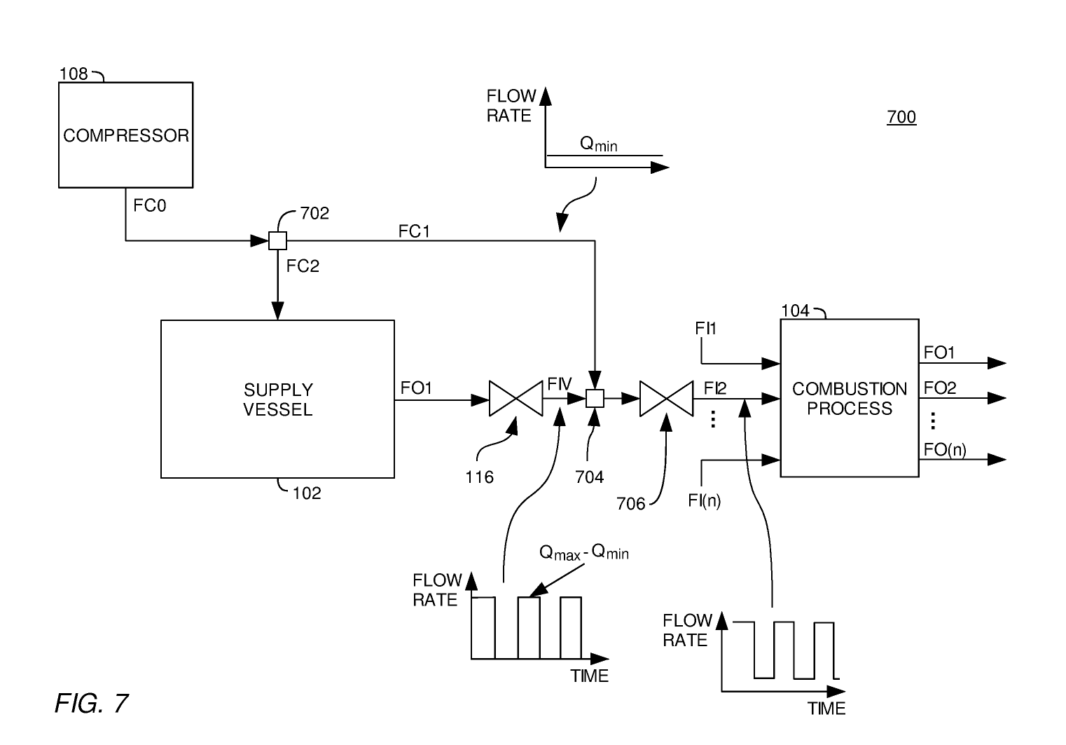

FIG. 7 illustrates a system 700 for providing an input flow to a process according to one embodiment of the invention. As depicted, a compressor 108 may be used to provide a source of gas within the system 700. The output flow FCO from the compressor 108 may be split by a valve 702 to provide two streams of gas (a first stream FC1 and a second stream FC2). The first stream FC1 may be used to provide a fixed minimum flow rate used by the process 104 while the second stream FC2 may be provided to the supply vessel 102. The supply vessel 102 may act as a buffer for the compressor 108 (e.g., by providing gas at a pressure which is essentially constant).

The supply vessel 102 may be used to provide the gas being supplied (via output flow FO1) to an oscillating valve 116. The oscillating valve may be used to provide a time-varying third stream of gas (FIV) which is combined with the first stream of gas FC1 by connection 704 to produce an input flow for the combustion process 104. In some cases, a pressure regulator 706 may also be used to regulate the pressure of the input stream F12 provided to the combustion process 104. For example, the pressure regulator 706 may be used to make smaller adjustments in the pressure of the input flow than those provided by the oscillating valve 704.

In one embodiment, by using the supply vessel 102 to provide gas to the oscillating valve 116, the pressure upstream of the oscillating valve 116 may be maintained while the oscillating valve 116 draws a varying amount of gas from the supply vessel 102. Furthermore, in some cases, because the first stream of gas FC1 may provide a fixed, minimum flow rate to the combustion process 104, control of the oscillating valve 116 may be simplified, for example, because the valve 116 may be actuated between an open and a closed position (e.g., to provide gas during fuel-lean and fuel-rich operation of the combustion process 104) as opposed to a fully open and a partially open position (e.g., as may be used where the oscillating valve 116 provides the minimum flow rate to the combustion process 104).

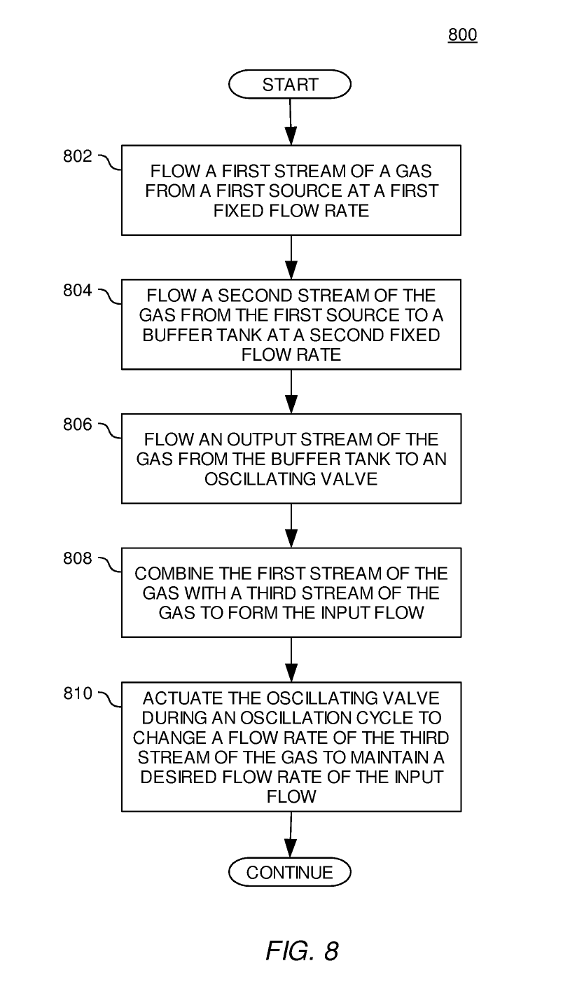

FIG. 8 illustrates a process 800 for providing an input flow to a process according to one embodiment of the invention. As depicted, the process 800 may begin at step 802 where a first stream of gas is flowed from a first source at a first fixed flow rate. At step 804, a second stream of gas may be flowed from the first source a buffer tank (e.g., supply vessel 102) at a second fixed flow rate. At step 806, an output stream of the gas may be flowed from the buffer tank to an oscillating valve 116, and at step 808 the first stream of the gas may be combines with a third stream of the gas produced by the oscillating valve 116 to form the input flow, e.g., for combustion process 104. At step 810, the oscillating valve 116 may be actuated during an oscillation cycle to change a flow rate of the third stream of the gas to maintain a desired flow rate of the input flow as described above.

### Conclusion

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method of maintaining a pressure within a supply tank, comprising:
measuring one or more output flows from the supply tank;
determining whether one or more input flows to the supply tank balance the one or more output flows; and
when the one or more input flows to the supply tank do not balance the one or more output flows, modifying at least one of the one or more input flows to balance the one or more output flows, thereby maintaining the pressure within the supply tank.

2. The method of claim 1, wherein determining if one or more input flows to the supply tank balance the one or more output flows is performed in the absence of measuring the pressure within the supply tank.

3. The method of claim 1, wherein measuring one or more output flows from the supply tank is performed with a separate mass-flow meter for each of the one or more output flows from the supply tank.

4. The method of claim 1, wherein modifying at least one of the one or more input flows to balance the one or more output flows comprises modifying an input flow from a compressor using a flow regulator.

5. The method of claim 1, further comprising:
providing one of the one or more output flows from the supply tank to an oscillating valve.

6. The method of claim 5, further comprising:
providing an output from the oscillating valve to an oscillating combustion process, wherein the oscillating combustion process comprises performing a first portion of a combustion cycle for a first time period at a first air-fuel ratio and performing a second portion of the combustion cycle for a second time period at a second air-fuel ratio.

7. A system, comprising:
a supply tank; and
a controller configured to:
measure one or more output flows from the supply tank;
determine if one or more input flows to the supply tank balance the one or more output flows; and
if the one or more input flows to the supply tank do not balance the one or more output flows, modify at least one of the one or more input flows to balance the one or more output flows, thereby maintaining a pressure within the supply tank.

8. The system of claim 7, wherein determining if one or more input flows to the supply tank balance the one or more output flows is performed without using a pressure sensor within the supply tank.

9. The system of claim 7, wherein measuring one or more output flows from the supply tank is performed with a separate mass-flow meter for each of the one or more output flows from the supply tank.

10. The system of claim 7, wherein modifying at least one of the one or more input flows to balance the one or more output flows comprises modifying an input flow from a compressor using a flow regulator.

11. The system of claim 7, wherein one of the one or more output flows from the supply tank is connected to an oscillating valve.

12. The system of claim 11, wherein an output from the oscillating valve is connected to an oscillating combustion process, wherein the oscillating combustion process is configured to perform a first portion of a combustion cycle for a first time period at a first air-fuel ratio and perform a second portion of the combustion cycle for a second time period at a second air-fuel ratio.

13. A method of maintaining a constant pressure in a supply vessel, the method comprising:
providing one or more input flows to the supply vessel;
providing one or more output flows from the supply vessel; and
if the one or more output flows from the supply vessel are greater than the one or more input flows to the supply vessel, diverting at least a first portion of at least one of the one or more input flows from the supply vessel to a buffer tank.

14. The method of claim 13, further comprising, if the one or more output flows from the supply vessel are less than the one or more input flows to the supply vessel, providing at least a second portion of the at least one of the one or more input flows from the buffer tank to the supply tank.

15. The method of claim 13, wherein diverting at least the first portion of at least one of the one or more input flows from the supply vessel to a buffer tank is performed by providing a pressure sensitive valve connected between the at least one of the one or more input flows and the buffer tank.

16. A system, comprising:
a supply tank with one or more output flows and one or more input flows;
a buffer tank; and
a valve positioned between the supply tank and the buffer tank, wherein the valve is configured to divert at least a first portion of at least one of the one or more input flows from the supply vessel to a buffer tank if the one or more output flows from the supply vessel are greater than the one or more input flows to the supply vessel.

17. The system of claim 16, wherein the valve is further configured to:
provide at least a second portion of the at least one of the one or more input flows from the buffer tank to the supply tank if the one or more output flows from the supply vessel are less than the one or more input flows to the supply vessel.

18. The system of claim 16, wherein the valve is a pressure sensitive valve.

19. A method of maintaining a constant pressure in a supply vessel, the method comprising:
providing one or more input flows to the supply vessel;
providing one or more output flows from the supply vessel; and
if the one or more output flows from the supply vessel are greater than the one or more input flows to the supply vessel, actuating a piston to decrease the volume of the supply vessel, thereby maintaining the constant pressure in the supply vessel.

20. The method of claim 19, further comprising:
if the one or more output flows from the supply vessel are less than the one or more input flows to the supply vessel, actuating the piston to increase the volume of the supply vessel, thereby maintaining the constant pressure in the supply vessel.

21. The method of claim 19, further comprising:
using a pressure-controlled valve to determine if the one or more output flows from the supply vessel are greater than the one or more input flows to the supply vessel.

22. The method of claim 19, further comprising:
using a pressure sensor within the supply vessel to determine if the one or more output flows from the supply vessel are greater than the one or more input flows to the supply vessel.

23. The method of claim 19, wherein the piston is a friction free piston.

24. A system, comprising:
a supply tank with one or more output flows and one or more input flows;
a piston; and
a control mechanism for the piston configured to actuate the piston to decrease the volume of the supply vessel if the one or more output flows from the supply vessel are greater than the one or more input flows to the supply vessel, thereby maintaining the constant pressure in the supply vessel.

25. The system of claim 24, wherein the control mechanism is further configured to:
actuate the piston to increase the volume of the supply vessel if the one or more output flows from the supply vessel are less than the one or more input flows to the supply vessel, thereby maintaining the constant pressure in the supply vessel.

26. The system of claim 24, wherein the control mechanism is a pressure-controlled valve.

27. The system of claim 24, wherein the control mechanism is a pressure sensor.

28. The system of claim 24, wherein the piston is a friction free piston.

29. A method of providing an input flow, comprising:
flowing a first stream of a gas from a first source at a first fixed flow rate;
flowing a second stream of the gas from the first source to a buffer tank at a second fixed flow rate;
flowing an output stream of the gas from the buffer tank to an oscillating valve;
combining the first stream of the gas with a third stream of the gas to form the input flow; and
actuating the oscillating valve during an oscillation cycle to change a flow rate of the third stream of the gas to maintain a desired flow rate of the input flow.

30. The method of claim 29, further comprising:
maintaining the pressure of the input flow at a desired pressure level using a pressure regulator.

32. The method of claim 29, wherein the oscillating valve is actuated between a first position and a second position, wherein the first position is a closed position and wherein the second position is an open position.

33. A system, comprising:
a buffer tank;
a first stream of a gas flowing from a first source at a first fixed flow rate;
a second stream of the gas flowing from the first source to the buffer tank at a second fixed flow rate;
an output stream of the gas flowing from the buffer tank to an oscillating valve;
a connection combining the first stream of the gas with a third stream of the gas to form an input flow; and
a control mechanism configured to actuate the oscillating valve during an oscillation cycle to change a flow rate of the third stream of the gas to maintain a desired flow rate of the input flow.

34. The system of claim 33, further comprising:
a pressure regulator configured to maintain the pressure of the input flow at a desired pressure level.

35. The system of claim 33, wherein the control mechanism is configured to actuate the oscillating valve between a first position and a second position, wherein the first position is a closed position and wherein the second position is an open position.
